(19) United States
(12) Patent Application Publication
(10) Pub. No.: US 2025/0105341 A1
(43) Pub. Date: Mar. 27, 2025

(54) SODIUM ION BATTERIES AND METHODS OF MANUFACTURE THEREOF

(71) Applicant: GM Global Technology Operations LLC, Detroit, MI (US)

(72) Inventors: Xingcheng Xiao, Troy, MI (US); Fang Dai, Troy, MI (US); Mei Cai, Bloomfield Hills, MI (US)

(21) Appl. No.: 18/471,362

(22) Filed: Sep. 21, 2023

(51) Int. Cl. H01M 10/054; H01M 4/02; H01M 4/04; H01M 4/38; H01M 50/403; H01M 50/491

(52) U.S. Cl. CPC H01M 10/054; H01M 4/0402; H01M 4/381; H01M 50/403; H01M 50/491; H01M 2004/021; H01M 2004/027; H01M 2004/028

(57) ABSTRACT

A sodium ion battery includes an anode, a cathode, a separator and an electrolyte. The anode includes an anode active layer, the cathode includes a cathode active layer and the separator includes a porous film. At least one of the anode active layer, the cathode active layer or the separator have an anode zeolite layer, a cathode zeolite layer or a separator zeolite layer respectively disposed thereon.

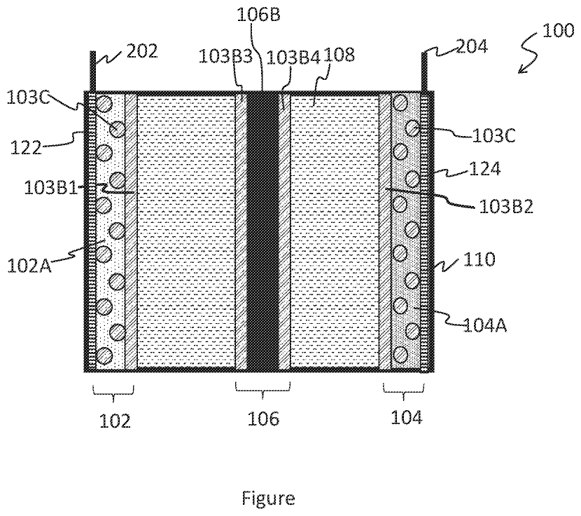

### INTRODUCTION

The subject disclosure relates to sodium ion batteries and to methods of manufacture thereof.

Sodium ion batteries display a number of advantages over lithium ion batteries. Their fast charge capabilities are at least 3 times greater than those of lithium ion batteries and they operate much more safely at higher temperatures than do lithium ion batteries. In addition, sodium is more abundantly available than lithium.

Sodium ion batteries however, are more moisture susceptible than lithium ion batteries and this results in a more rapid deterioration of sodium ion batteries when compared with their lithium ion counterparts. In addition, some of the electrolytes used in sodium ion batteries undergo hydrolysis to form hydrofluoric acid. This hydrofluoric acid attacks the electrodes slowly destroying them. Transition metals used in the battery often undergo dissolution in the hydrofluoric acid resulting in a loss of charging capacity. It is therefore desirable to develop a sodium ion battery that is free of these drawbacks.

### SUMMARY

In an embodiment, a sodium ion battery includes an anode, a cathode, a separator and an electrolyte. The anode includes an anode active layer, the cathode includes a cathode active layer and the separator includes a porous film. At least one of the anode active layer, the cathode active layer or the separator have an anode zeolite layer, a cathode zeolite layer or a separator zeolite layer respectively disposed thereon.

In another embodiment, the anode zeolite layer, the cathode zeolite layer and the separator zeolite layer all have the same composition.

In yet another embodiment, the anode zeolite layer, the cathode zeolite layer and the separator zeolite layer all have a different composition.

In yet another embodiment, a zeolite used in the anode zeolite layer, the cathode zeolite layer and the separator zeolite layer is sodium zeolite A-NaA, sodium zeolite X—NaX, sodium zeolite Y—NaY, sodium zeolite ZSM-5, sodium clinoptilolite, or a combination thereof.

In yet another embodiment, the anode active layer or the cathode active layer have zeolite particles dispersed therein.

In yet another embodiment, the anode zeolite layer, the cathode zeolite layer and the separator zeolite layer all comprise zeolite particles having a particle size of 100 nanometers (nm) to 5 micrometers (μm), with a D50 value of 300 nanometers.

In yet another embodiment, the zeolite particles are subjected to a sodium ion exchange process prior to being used in the sodium ion battery.

In yet another embodiment, the anode zeolite layer or the cathode zeolite layer have a porosity of 20 to 40 volume percent based on a total volume of the anode zeolite layer or the cathode zeolite layer, respectively.

In yet another embodiment, the separator zeolite layer has a broader porosity range than either the anode zeolite layer or the cathode zeolite layer.

In yet another embodiment, the separator zeolite layer has a porosity of 30 to 70 volume percent based on a total volume of the separator zeolite layer.

In yet another embodiment, the zeolite particles in the anode active layer or the cathode active layer are present in an amount of up to 10 wt %, based on a total weight of the anode active layer or a total weight of the cathode active layer.

In yet another embodiment, the anode zeolite layer or the cathode zeolite layer have a thickness of 500 nanometers to 10 micrometers.

In yet another embodiment, the separator zeolite layer has a thickness of 1 to 10 micrometers.

In yet another embodiment, the separator zeolite layer is disposed on opposing surfaces of the separator film.

In an embodiment, a method of manufacturing a sodium on battery includes disposing an anode zeolite layer on an anode active layer that is in contact with an anode current collector; or disposing a cathode zeolite layer on a cathode active layer that is in contact with a cathode current collector; or disposing a separator zeolite layer on a separator that is disposed between the cathode active layer and the anode active layer. The anode active layer, the cathode active layer and the separator are then disposed in a housing.

In yet another embodiment, zeolite particles are disposed in the anode active layer or in the cathode active layer.

In yet another embodiment, an anode zeolite layer is disposed on an anode active layer that is in contact with an anode current collector and a cathode zeolite layer is disposed on a cathode active layer that is in contact with a cathode current collector.

In yet another embodiment, a separator zeolite layer is disposed on a separator that is disposed between the cathode active layer and the anode active layer.

In yet another embodiment, the anode zeolite layer or the cathode zeolite layer have a porosity of 20 to 40 volume percent based on a total volume of the anode zeolite layer or the cathode zeolite layer, respectively.

In yet another embodiment, the separator zeolite layer has a porosity of 30 to 70 volume percent based on a total volume of the separator zeolite layer.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

The FIGURE is a cross-sectional view of an exemplary embodiment of the sodium ion battery.

### DETAILED DESCRIPTION

The following description is merely exemplary in nature and is not intended to limit the present disclosure, its application or uses.

In accordance with an exemplary embodiment, disclosed herein are sodium ion batteries that utilize zeolite as a ceramic coating on a separator surface or on an electrode surface. In another embodiment, the zeolite may be used in the bulk of an electrode active layer. In other words, it can be dispersed across the volume of an electrode active layer. To prevent cross-contamination, the zeolite is first subjected to a sodium ion exchange process to eliminate undesirable cations, such as potassium. It is then either used in a coating on surfaces of the separator or one or more surfaces of one or more electrodes. It may also optionally be dispersed in the volume of an active material layer. The use of zeolites enhance electrolyte wettability, effectively capturing trace water and transition metal ions which are dissolved from cathode materials in sodium ion batteries. It also acts as a scavenger for hydrofluoric acid thus protecting the cathode from corrosion and increasing the life cycle for sodium ion batteries.

Zeolites are microporous, crystalline aluminosilicate materials commonly used as commercial adsorbents and catalysts. They comprise silicon, aluminum, oxygen, and have the general formula Mⁿ⁺_{1/n}(AlO₂)—(SiO₂)ₓ·yH₂O where Mⁿ⁺_{1/n is either a metal ion or H}⁺. These positive ions can be exchanged for others in a contacting electrolyte solution. H⁺ exchanged zeolites are particularly useful as solid acid catalysts. Prior to being used in a sodium ion battery, the zeolite is subjected to an ion exchange process to displace other extraneous undesirable ions present in the zeolite with sodium ions. The ion exchange process may be conducted in a solution based process or in a solid state process.

In the solution based process, the zeolite is first dispersed in an aqueous solution of a sodium salt. Examples of sodium salts are sodium hydroxide, sodium chloride, sodium carbonate, sodium nitrite, sodium nitrate, sodium hydrogen carbonate, sodium sulfate, or a combination thereof. Sodium hydroxide is often used. The aqueous solution with the sodium salt and with the zeolite dispersed therein is stirred in a reaction vessel at a temperature of 70 to 90° C., and 75 to 85° C. for a period of 30 minutes to 3 hours, or 1 to 2 hours. During this heating process, extraneous undesirable ions present in the zeolite are replaced with sodium ions derived from the sodium hydroxide. The zeolite thus treated is then removed from the reaction vessel, subjected to drying and calcinated at a temperature of 400° C. for a period of greater than or equal to 2 hours, and greater than or equal to 3 hours. The treated zeolite may optionally be subjected to grinding or ball milling to reduce particle size.

In the solid state ion exchange process, a sodium precursor such as one of the sodium salts listed above is mixed with the zeolite to form a mixture. The mixing can be conducted in a Waring blender, a Henschel mixer, a ball mill, a planetary mixer, a Banbury mixer, or a combination thereof. Following the mixing, the mixture is removed from the mixer and subjected to calcination at a temperature of 600° C. or greater for a period of greater than or equal to 2 hours, and greater than or equal to 3 hours. The mixture is then subjected to grinding or ball milling to reduce particle size. The reduced particle size obtained after the solution based ion exchange process or the solid state ion exchange process is 100 nanometers (nm) to 5 micrometers (μm), with a D₅₀ value of 300 nanometers. The D₅₀ (also written as D₅₀) is the mean or average particle size of a group of particles. So “D₅₀=300 nanometers” means the average particle size of that mineral is 300 nanometers. It also means that 50% of the particles are smaller than 300 nanometers and 50% are larger than 300 nanometers.

The particles of the sodium containing zeolite may then be applied on the separator surface and the electrode surface and/or dispersed throughout the volume of the electrodes. The FIGURE depicts one exemplary embodiment of a sodium ion battery 100 where surfaces of the electrodes and separator have a layer of zeolite disposed on them. The battery 100 comprises a housing 110 in which are disposed electrodes (an anode 102 and a cathode 104), a separator 106 and an electrolyte 108. The anode 102 is in contact with an anode current collector 122, while the cathode 104 is in contact with a cathode current collector 124. The anode current collector is in electrical communication with terminal 202, while the cathode current collector is in electrical communication with terminal 204. The terminals 202 and 204 are in electrical communication with a load (not shown).

In an embodiment, the anode 102 comprises an anode active layer 102A (which contains an anode active material) and an anode zeolite layer 103B1 disposed on a surface of the anode active layer 102A, while the cathode 104 comprises a cathode active layer 104A (which contains a cathode active material) and a cathode zeolite layer 103B2 disposed on a surface of the cathode active layer 104A. The separator 106 comprises an insulating separator 106B upon whose opposing surfaces are disposed separator zeolite layers 103B3 and 103B4. The electrolyte 108 surrounds the anode 102, the cathode 104 and the separator 106. The anode active layer 102A and the cathode active layer 104A may optionally contain zeolite particles 103C dispersed throughout the bulk of the anode active material and the cathode active material. The zeolite layers on the anode (103B1), the cathode (103B2) and the separator (103B3 and 103B4) may have the same zeolite compositions or may have different compositions. In an embodiment, the zeolite compositions on the anode, the cathode and the separator are all the same.

It is to be noted that the zeolite layer may be disposed on any one of the anode active layer, the cathode active layer or the separator. It may be disposed on two or more of the anode active layer, the cathode active layer or the separator. It may also be disposed on one surface of the separator or on both opposing surfaces of the separator.

The following paragraphs describe the materials used in the anode active layer, followed by the cathode active layer and the separator before describing the zeolite layers and their manufacture.

The anode 102 comprises an anode active layer 102A upon which is disposed an anode zeolite coating 103B. The anode active layer 102A comprises an anode active material. The anode active material comprises hard carbon, graphene, graphite, sodium alloys with metals of Group IVA and VA metals, metal based oxides, sulfide and/or phosphides, or a combination thereof.

Hard carbon is a disordered carbon material that comprises a non-graphitizable, non-crystalline and amorphous carbon. Hard carbon is a solid form of carbon that cannot be converted to graphite by heat-treatment, even at temperatures as high as 3000° C. It is also known as char or “non-graphitizing” carbon. Hard carbon is produced by heating carbonaceous precursors to approximately 1000° C. in the absence of oxygen. Among the precursors for hard carbon are polyvinylidene chloride (PVDC), lignin and sucrose. Hard carbon has shown an ability to absorb sodium.

Graphene is an allotrope of carbon consisting of a single layer of atoms arranged in a hexagonal lattice nanostructure. Graphene that is added to the anode active layer may be in the form of individual graphene sheets or in the form of a plurality of loosely connected graphene sheets. Each atom in a graphene sheet is connected to its three nearest neighbors by σ-bonds and a delocalized-bond, which contributes to a valence band that extends over the whole sheet. This is the same type of bonding seen in carbon nanotubes and polycyclic aromatic hydrocarbons, and in fullerenes and glassy carbon. The valence band is touched by a conduction band, making graphene a semimetal with unusual electronic properties that are best described by theories for massless relativistic particles.

In an embodiment, the graphene can be in the form of graphene nanoplatelets (GNP). Exfoliated graphene nano-platelets comprise nanoparticles that contain graphite. These nanoparticles consist of small stacks of graphene that are 1 to 15 nanometers thick, with diameters ranging from sub-micrometer to 100 micrometers.

Graphite particles may also be used as the anode active material. Graphite is a natural manifestation of pure carbon with a hexagonal crystal structure that is arranged in several parallel levels, called graphene layers. In short, graphite particles comprise a plurality of graphene sheets that are arranged to be parallel to each other. This anisotropic structure gives the graphite special properties, such as electrical conductivity or a particular strength along the individual layers. It is extremely heat-resistant with a sublimation point of over 3,800° C., thermally highly conductive and chemically inert.

Group IVA and VA metals (such as antimony (Sb) and tin (Sn)) have been calculated to deliver high capacities by forming sodium-rich intermetallic compounds such as Na₃Sb, and Na₁₅Sn₄ through alloying reaction mechanisms. These tin and antimony compounds exhibit alloying reaction mechanisms, which make them useful as anode active materials. In an embodiment, a sodium-tin alloy may also be used as the anode active material. The alloy of sodium and metallic tin (Na₁₅Sn₄) is typically formed through a spontaneous reaction and may be used as the anode active material. The sodium-tin alloy has an ability to operate at extreme temperatures and regulate dendritic growth.

The metal based oxides, sulfides, and phosphides with different chemical structures exhibit sodiation behavior via conversion reactions. Sodiation is the replacement of metal ions such as lithium with sodium ions. The metal oxides (MOx) and metal sulfides (MSα), especially layered metal disulfides may be used as anode materials based on conversion reactions. In most cases, the conversion reaction is accompanied by an intercalation or alloying reaction during the sodium insertion process. The generalized formula for Na-based conversion reaction can thus be written as

MₐX_{b}+b_{c}Na< - - - - - - ->aM+bNa_{c}X

where X represents either oxygen or sulfur in the host compound, and a, b, and c are the stoichiometric composition of the starting material, and the formed Na-containing compound, respectively. In metal sulfides, sodium is intercalated to form NaₓMSₐ, and after further intercalation, sodium is decomposed into Na₂S and M through the conversion reaction. Also, the conversion reaction is associated with slow kinetics and large volume expansion. The reaction path in the conversion reaction based on metal oxides depends on whether the metal M is electrochemically active for alloying.

Oxides such as TiO₂ and Nb₂O₅ can undergo intercalation with sodium ions, which provides these materials with high rate capabilities. In an embodiment, molybdenum sulfide has a layered structure and may also be used as the anode active material.

The cathode 104 comprises a cathode active layer 104A which contains a cathode active material. Sodium-ion cathode active materials store sodium via intercalation. Examples of cathode active materials include metal oxides, layered oxides, polyanion compounds, or a combination thereof.

Metal oxides (MOx) are used as cathode active materials in sodium ion batteries because of their good electrical conductivity and because of their electrochemical properties related to specific capacity, rate capability and cycling stability. For example, due to its excellent structural flexibility, low cost, and high abundance, vanadium oxide is often used in cathode active materials. Owing to their high tap density, high operating potentials and high capacities, cathodes based on sodium transition metal oxides are often used. A P2-type Na_{2/3}Fe_{1/2}Mn_{1/2}O₂ metal oxide from earth-abundant Fe and Mn resources can reversibly store 190 mAh/g at average discharge voltage of 2.75 V vs Na/Na⁺ utilizing the Fe^{3+/4+} redox couple—on par or better than commercial lithium-ion cathodes such as LiFePO₄ or LiMn₂O₄.

Examples of other metal oxides that may be used as cathode active materials include a mixed P3/P2/O3-type Na_{0.76}Mn_{0.5}Ni_{0.3}Fe_{0.1}Mg_{0.1}O₂, O3-type NaNi_{1/4}Na_{1/6}Mn_{2/12}Ti_{4/12}Sn_{1/12}O₂, NaₐNi_{(1-x-y-z)}MnₓMg_{y}Ti_{z}O₂, Na_{0.67}Mn₁₋ₓMgₓO₂, Na_{0.67}Mn_{0.95}Mg_{0.05}O₂, Na_{0.67}Ni_{0.3-x}CuₓMn_{0.7}O₂, or a combination thereof; where x, y and z can each independently have values of 0.001 to 0.1.

Some of the aforementioned metal oxides can be layered oxides. Since the layered oxide compounds have a content of sodium, they could be classified into different types, O3, P2 or P3. The letter P is referred to as the trigonal prismatic coordination, while the letter O represents the octahedral prismatic coordination. On the other hand, numbers 2 and 3 are related to the layer numbers in the original cells.

Layered oxide compounds, which are of interest as cathode materials for sodium ion batteries, often have a formula NaₓMO₂, where M is referred to as different types of transition metals such as Cr and Mn and were x is 0.2 to 0.8, and 0.4 to 0.6. Due to the difference between the size of sodium and lithium ions, NaₓMO₂ could achieve more types of compounds than lithium, capable of sodium reversible incorporation. For example, the Na_{0.5}MO₂ compound referred to the 03 type and is thermodynamically not inclined to switch to spinel structure compared to Li_{0.5}MO₂. In addition, the transition metal atoms in the sodium compounds with 03 types are more stable than those in the lithium compounds.

Polyanionic compounds have shown promising performance as positive electrode materials sodium ion batteries. Examples of polyanionic compounds include phosphate-based polyanionic compound (TiO)₂P₂O₇, vanadium (V)-based polyanionic compounds, sodium (Na) super ionic conductor (NASICON) polyanionic compounds, or a combination thereof.

As noted above, the anode active material and the cathode active material may contain zeolite particles (103C) dispersed therein. This will be detailed later.

The separator 106 is a porous, electrically insulating film. Battery separators provide a barrier between the anode 102 and the cathode 104 while enabling the exchange of sodium ions from one side to the other. The separator does not undergo any reactivity with the electrolyte or other ions used in the sodium ion battery. The separator 106 is a porous polymeric film that comprises a polyolefin (e.g., polyethylene, propylene, or a combination thereof), a polyimide, a polyaramid, a polyfluoroethylene (e.g., polytetrafluoroethylene), or a combination thereof. The separator 106 has a thickness of 5 to 20 micrometers and a porosity of 40 to 60 volume percent.

As noted above, zeolite layers are disposed on the surfaces of the anode 102 (zeolite layer 103B1), the cathode 104 (zeolite layer 103B2) and the separator 106 (zeolite layers 103B3 and 103B4). The zeolite particles may also be dispersed throughout the volume of the anode and cathode active layers (103C). These zeolite layers and dispersed particles will now be detailed.

The zeolite layers typically contain a sodium containing zeolite and a binder. Examples of the sodium containing zeolite are sodium zeolite A-NaA, sodium zeolite X—NaX, sodium zeolite Y—NaY, sodium zeolite ZSM-5, sodium clinoptilolite, or a combination thereof. As noted above, the zeolite is typically in particle form having a particle size of 100 nm up to 5 micrometers with a D₅₀ of 300 nanometers. The zeolite is typically present in an amount of 60 to 90 wt %, and 75 to 85 wt %, based on a total weight of each of the zeolite layers (103B1, 103B2, 103B3 or 103B4).

The zeolite layer typically comprises a binder that provides some mechanical integrity to the zeolite layer. The binder is stable in the electrolyte and other reaction byproducts that are formed in the electrolyte during the life of the battery. The binder is used in an amount that permits the electrolyte to access the pores in the zeolites. In other words, the binder should not seal off a substantial portion of the pores in the zeolite particles.

In an embodiment, the binder is an organic polymer. The organic polymer may be a thermoplastic polymer, a thermosetting polymer, or a combination thereof. The organic polymer may be a homopolymer, a copolymer, a blend of homopolymers, a blend of copolymers, or a combination thereof.

Examples of thermoplastic polymers include polyolefins, polyimides, polyamides, polyfluoroethylenes (e.g., polytetrafluoroethylene), polysiloxanes (e.g., polydimethylsiloxane), polyaramides, or a combination thereof. Examples of thermosetting polymers include epoxies, phenolics, polyurethanes, polysiloxanes, polybutadienes, polyisoprenes, or a combination thereof.

In an embodiment, in the application of the zeolite layer to the anode active layer (103B1), the cathode active layer (103B2) and the separator (103B3 and 103B4), the binder and the zeolite particles may be mixed with a solvent to form a slurry. The slurry may be mixed in a ball mill (or alternatively in some of the other mixers listed above) to bring intimate contact between the binder and the zeolite particles. The slurry is then applied to the anode active layer, the cathode active layer or to the separator and dried to form the respective zeolite layer.

The anode and cathode active layers and the separator along with the respective zeolite layers disposed thereon may optionally be heated to a temperature near the solvent boiling point but below the glass transition temperature of the binder to remove any undesirable traces of solvent before being disposed in the housing 110. The respective zeolite layers (103B1, 103B2) applied to the anode active layer 102A and the cathode active layer 104A each have a thickness of 500 nm to 10 micrometers, and 1 to 8 micrometers. The zeolite layers 103B3 and 103B4 applied to opposing surfaces of the separator 106 each have a thickness of 1 to 10 micrometers, and 2 to 8 micrometers. The zeolite layers applied to the separator 106 has a much broader range of porosity (30 to 70 volume percent, based on total volume of the zeolite layers 103b3 or 103B4) when compared with the zeolite layers applied to the anode active layer 102A and the cathode active layer 104A (20 to 40 volume percent, based on a total volume of the zeolite layer 103B1 or 103B2).

When the zeolite particles 103C are introduced into the anode active layer 102 or the cathode active layer, the anode active material and the cathode active material in particulate form is blended with the zeolite particles. A polymeric binder may optionally be used in the anode active layer or the cathode active layer.

The polymeric binder may be a fluorine containing homopolymer or copolymer. In an embodiment, the binder is a fluorine containing copolymer. In an embodiment, the fluorine containing copolymer is at least one of poly(vinylidene fluoride-co-chlorotrifluoroethylene) (abbreviated as P(VDF-CTFE)), poly(vinylidene fluoride-trifluoroethylene) (abbreviated as P(VDF-TeFE)), poly(vinylidene fluoride-trifluoroethylene-chlorofluoroethylene) terpolymer (abbreviated as P(VDF-TrFE-CFE)), poly(vinylidene fluoride-hexafluoropropylene) (abbreviated as P(VDF-HFP) or PVDF-HFP), or a combination thereof. In an embodiment, the polymeric binder used in the active layer is poly(vinylidene fluoride-hexafluoropropylene) copolymer. The polymeric binder has a weight average molecular weight of 5,000 to 1,000,000 grams per mole, 50,000 to 750,000 grams per mole, and 75,000 to 500,000 grams per mole measured using gel permeation chromatography with a polystyrene standard.

In an embodiment, the polyvinylidene content of any of the aforementioned binders is 80 to 95 wt %, based on a total weight of the polymeric binder. The remaining polymer content of the copolymer is 5 to 20 wt %, based on the total weight of the polymeric binder. For example, if the polymeric binder is a poly(vinylidene fluoride-hexafluoropropylene) copolymer, then the polyvinylidene content of the copolymer is 80 to 95 wt %, based on a total weight of the polymeric binder, while the poly hexafluoropropylene content of the copolymer is 5 to 20 wt %, based on a total weight of the copolymer.

The total weight of the polymeric binder in the active layer after the solvent is removed is less than 10 wt %, less than 8 wt %, less than 5 wt %, and less than 3 wt % of a total weight of the active layer. The polymeric binder if present, is present in an amount of greater than 0.1 wt % of the total weight of the active layer. A lower weight of the polymeric binder in the active layer facilitates a lower reduction in the electrically conducting capabilities of the active layer. In other words, the lower the amount of the polymeric binder, the greater the electrical conducting capacity of the active layer will be. The active layer is disposed on the current collector and comprises the pertinent (anode or cathode) active material, the electrically conducting additive and the polymeric binder.

In the manufacturing of the anode active layer 102A and the cathode active layer 104A, the respective active material (the anode active material or the cathode active material), the zeolite particles and the binder (in the form of particles) in the appropriate quantity may be ground together in a ball mill and molded to form the respective anode or cathode active layer. The active layer may be disposed on the respective current collector. Prior to or after the disposing of the active layer on the respective current collector, a zeolite layer may be optionally disposed on the active layer by adding a coating of the slurry to a surface of the active layer that is opposed to the surface that contacts the current collector. The anode active layer and/or the cathode active layer may therefore have zeolite particles disposed within the volume of the layer and may optionally contain a zeolite layer disposed on its surface.

The zeolite particles 103C present in the anode active layer 102A or the cathode active layer 104A may be present in an amount of up to 10 wt %, up to 8 wt %, and up to 6 wt %, based on a total weight of the respective active layer. The zeolite particles dispersed in active layer as well as those present in the zeolite layer (which is disposed on a surface of the active layer) have particles with a particle size of 100 nm up to 5 micrometers with a D₅₀ of 300 nanometers.

The anode 102 and the cathode 104 may then be disposed in the housing 110 in the desired locations. The electrolyte may be then be charged to the housing 110. Sodium-ion batteries can use aqueous and non-aqueous electrolytes. The limited electrochemical stability window of water results in lower voltages and limited energy densities. Non-aqueous carbonate ester polar aprotic solvents extend the voltage range. These include ethylene carbonate, dimethyl carbonate, diethyl carbonate, and propylene carbonate. The most widely used salts in non-aqueous electrolytes are NaClO₄ and sodium hexafluorophosphate (NaPF₆) dissolved in a mixture of these solvents. In addition, NaTFSI (TFSI=bis(trifluoromethane)sulfonimide) and NaFSI (FSI=bis(fluorosulfonyl)imide), NaDFOB (DFOB=difluoro(oxalato)borate) and NaBOB (bis(oxalato)borate) anions may be added to the solvent to form the electrolyte. Sodium sulfate (Na₂SO₄) is a strong electrolyte, providing sodium ions in an aqueous solution.

When the sodium ion battery is charged, sodium ion is separated from the cathode active material. Sodium ions enter the electrolyte. It reaches the negative electrode through the porous separator 106 and is embedded in the lattice of the anode active material. The electrochemical reaction will result in low lithium content in the cathode and high lithium content in the anode. During discharge, sodium-ion is separated from the anode active material. Sodium ions enter the electrolyte and pass through the separator 106 and is embedded in the lattice of the cathode active material. In this manner, sodium-ion de sodium and sodium intercalation between the cathode and anode occurs during charging and discharging.

Following the addition of the electrolyte to the housing 110, the separator 106 can be installed in the housing and the housing sealed to form the sodium battery. The terminals 202 and 204 can be affixed to the housing and contacted with the anode current collector 122 and the cathode current collector 124. The sodium ion battery is now ready for commercial use.

Sodium ion batteries thus manufactured can harness the potential of sodium in zeolite. Sodium is less expensive than lithium, which results in less expensive batteries. Material synthesis and scale-up processes are simplified because of the large availability of sodium and its salts as compared with lithium and its salts. The increased specific surface area of zeolite facilitates the adsorption of trace water, effectively reducing side reactions that lead to electrode degradation. The zeolite acts as a trap for transition metal ions dissolved from the cathodes, safeguarding the solid electrolyte interface (SEI) formed on the anodes from damage. Applying a coating on the separator further enhances thermal stability and provides barriers against sodium dendrite penetration and short circuits.

The terms “a” and “an” do not denote a limitation of quantity, but rather denote the presence of at least one of the referenced item. The term “or” means “and/or” unless clearly indicated otherwise by context. Reference throughout the specification to “an aspect,” means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A sodium ion battery comprising:
an anode; where the anode comprises an anode active layer;
a cathode; where the cathode comprises a cathode active layer; and
a separator; where the separator comprises a porous film; where at least one of the anode active layer, the cathode active layer or the separator have an anode zeolite layer, a cathode zeolite layer or a separator zeolite layer respectively disposed thereon; and
an electrolyte.

2. The sodium ion battery of claim 1, where an anode zeolite layer, a cathode zeolite layer and a separator zeolite layer all have a same composition.

3. The sodium ion battery of claim 1, where an anode zeolite layer, a cathode zeolite layer and a separator zeolite layer all have a different composition.

4. The sodium ion battery of claim 1, where a zeolite used in the anode zeolite layer, the cathode zeolite layer and the separator zeolite layer is sodium zeolite A-NaA, sodium zeolite X—NaX, sodium zeolite Y—NaY, sodium zeolite ZSM-5, sodium clinoptilolite, or a combination thereof.

5. The sodium ion battery of claim 1, wherein the anode active layer or the cathode active layer have zeolite particles dispersed therein.

6. The sodium ion battery of claim 1, where the anode zeolite layer, the cathode zeolite layer and the separator zeolite layer all comprise zeolite particles having a particle size of 100 nanometers (nm) to 5 micrometers (μm), with a D₅₀ value of 300 nanometers.

7. The sodium ion battery of claim 6, wherein the zeolite particles are subjected to a sodium ion exchange process prior to being used in the sodium ion battery.

8. The sodium ion battery of claim 1, where the anode zeolite layer or the cathode zeolite layer have a porosity of 20 to 40 volume percent based on a total volume of the anode zeolite layer or the cathode zeolite layer, respectively.

9. The sodium ion battery of claim 1, where the separator zeolite layer has a broader porosity range than either the anode zeolite layer or the cathode zeolite layer.

10. The sodium ion battery of claim 1, where the separator zeolite layer has a porosity of 30 to 70 volume percent based on a total volume of the separator zeolite layer.

11. The sodium ion battery of claim 5, where the zeolite particles in the anode active layer or the cathode active layer are present in an amount of up to 10 wt %, based on a total weight of the anode active layer or a total weight of the cathode active layer.

12. The sodium ion battery of claim 1, where the anode zeolite layer or the cathode zeolite layer have a thickness of 500 nanometers to 10 micrometers.

13. The sodium ion battery of claim 1, where the separator zeolite layer has a thickness of 1 to 10 micrometers.

14. The sodium ion battery of claim 1, where the separator zeolite layer is disposed on opposing surfaces of the porous film.

15. A method of manufacturing a sodium ion battery comprising:
disposing an anode zeolite layer on an anode active layer that is in contact with an anode current collector; or
disposing a cathode zeolite layer on a cathode active layer that is in contact with a cathode current collector; or
disposing a separator zeolite layer on a separator that is disposed between the cathode active layer and the anode active layer; and
disposing the anode active layer, the cathode active layer and the separator in a housing.

16. The method of claim 15, further comprising disposing zeolite particles in the anode active layer or the cathode active layer.

17. The method of claim 15, further comprising disposing an anode zeolite layer on an anode active layer that is in contact with an anode current collector and disposing a cathode zeolite layer on a cathode active layer that is in contact with a cathode current collector.

18. The method of claim 17, further comprising disposing a separator zeolite layer on a separator that is disposed between the cathode active layer and the anode active layer.

19. The method of claim 15, wherein the anode zeolite layer or the cathode zeolite layer have a porosity of 20 to 40 volume percent based on a total volume of the anode zeolite layer or the cathode zeolite layer, respectively.

20. The method of claim 15, wherein the separator zeolite layer has a porosity of 30 to 70 volume percent based on a total volume of the separator zeolite layer.
